(19) United States
(12) Patent Application Publication
(10) Pub. No.: US 2026/0249110 A1
(43) Pub. Date: Aug. 27, 2026

(54) Facemask Assemblies with Multi-Mounts

(71) Applicant: OCTO SAFETY DEVICES, LLC, Miami, FL (US)

(72) Inventors: Tobias Franoszek, Miami, FL (US); Keith R. Coponi, Plantation, FL (US)

(21) Appl. No.: 19/652,270

(22) Filed: Apr. 20, 2026

Related U.S. Application Data
(63) Continuation of application No. PCT/US2024/052611, filed on Oct. 23, 2024.
(60) Provisional application No. 63/592,316, filed on Oct. 23, 2023.

(51) Int. Cl. A62B 23/02; A62B 7/10

(52) U.S. Cl. CPC A62B 23/025; A62B 7/10

(57) ABSTRACT

In some embodiments, a facemask assembly can include a core frame, a facial skirt, a filter assembly, and a front section. In some embodiments, a facemask assembly can include a core frame, a facial skirt, a filter assembly, a front section, and multi-mounts configured to attach a strap system and/or accessories to the facemask assembly.

### CROSS-REFERENCE TO RELATED APPLICATION

This application is a continuation of International Patent Application PCT/US2024/052611, filed Oct. 23, 2024, entitled “Facemask Assemblies with Multi-Mounts”. The '611 application is related to and claims priority benefits from U.S. Patent Application Ser. No. 63/592,316 filed Oct. 23, 2023, entitled “Facemask Assemblies with Multi-Mounts”. The '611 and '316 application are hereby incorporated by reference herein in their entireties.

### FIELD OF THE INVENTION

The present disclosure relates to facemask assemblies. In particular the disclosure relates to facemask assemblies with multi-mounts. More particularly, the disclosure relates to facemask assemblies with a core frame, a facial skirt, a filter assembly, a front section, and/or multi-mounts configured to attach strap assemblies and/or accessories to the facemask assembly.

Facemask assemblies are designed to protect the wearer and others in the vicinity of the wearer from airborne pathogens including bacteria and viruses. Facemasks are typically worn over the mouth and nose and can incorporate a form of eye protection.

Masks can be used in environments with high levels of airborne particulates and/or allergens where the wearer wishes to not inhale said particulates. To effectively reduce a wearer's exposure to airborne substances, a respiratory protection device needs to fit well and effectively filter out said substances.

Preventing inhalation and contact with airborne pathogens and environmental allergens is not only important in environments that require high levels of air purity, such as hospitals, but also in homes of people suffering from allergies. Additionally, wearers suffering from respiratory infections can benefit from the filter capture of pathogens and allergens when out in public. Masks are also often worn by users working in environments including particulate in the air, for instance in construction sites and work zones.

Conventional masks can be attached to the wearer's head by means of tie straps, elastic straps headbands, and/or nonadjustable holes cut into the mask designed to fit around the wearer's ear. Alternatively, masks can be fastened using elastic straps around the head or ears. Rectangular cross-sectional elastics are often used in one-size-fits-all nonadjustable masks. These masks are often uncomfortable as they can stretch and/or pinch the skin around the ears and back of the head. Similarly, conventional single and double strap systems are often uncomfortable and complicated to adjust to an individual face. This can lead to failure to seal the mask to the face, rendering the mask useless.

In addition, conventional masks are often required to be disposable as the strapping material tends to capture skin excretions as well as airborne particulates and pathogens and is difficult to clean.

To be effective in reducing a wearer's exposure to airborne substances, a respiratory protection device needs to have a sufficient fit as well as high filtration efficiency. However, conventional masks often provide a poor seal between the mask and the face and/or do not provide a way to easily determine if a proper seal has been formed.

What is needed are facemask assemblies that are easily disinfected/sterilized, are readily adjustable (including the ability to be readily tilted), provide a proper seal on a variety of face sizes and shapes, have a seal that can be easily verified, are customizable with various attachments, and/or provide a way to keep the inside of the mask from contamination while not in use.

### SUMMARY OF THE INVENTION

A facemask assembly can include a first multi-mount, a second multi-mount, a core frame; a facial skirt; a filter assembly; a front section; an accessory; and/or a head harness/strap system.

In some embodiments, a filter assembly includes a filter material; and a filter frame. In some embodiments, the filter material is pleated. In some embodiments, the filter frame includes a top piece and a bottom piece, wherein the top piece and the bottom piece are configured to sandwich the filter material.

In some embodiments, the filter material is a spunbond nylon fabric bonded with a silver substrate during the manufacturing process, to which nano fiber is added. In some embodiments, the filter material is an antimicrobial material. In some embodiments, the filter material releases positively-charged silver ions when activated by moisture.

In some embodiments, the core frame includes a first attachment member configured to attach the facial skirt to the core frame. In some embodiments, the core frame includes a second attachment member configured to attach the front section to the core frame. In some embodiments, the first attachment member serves as a vent for the facemask assembly. In some embodiments, the second attachment member serves as a vent for the facemask assembly.

In some embodiments, the facial skirt includes a first layer and a second layer.

In some embodiments, the front section includes at least one a y-shaped gap. In some embodiments, the front section includes at least one crescent-shaped gap. In some embodiments, the front section includes a first hole configured to receive a first multi-mount. In some embodiments, the front section includes a second hole configured to receive a second multi-mount.

In some embodiments, a multi-mount includes a cylindrical body; an attachment end; a first collar; and/or a second collar.

In some embodiments an accessory if configured to attach to at least one multi-mount. In some embodiments, the accessory can be a lighting accessory; an eye shield; a magnifier; an environmental sensor; and/or an augmented reality display.

Methods of connecting an accessory to a facemask assembly with a multi-mount are also disclosed.

### BRIEF DESCRIPTION OF THE DRAWINGS

FIG. 1 is a perspective front view of an embodiment of a facemask assembly.

FIG. 2 is an exploded perspective side view of an embodiment of a facemask assembly.

FIG. 3 is an exploded perspective side view of an embodiment of a filter assembly and a facial skirt.

FIG. 4 is a cross-sectional perspective view of an embodiment of a facial skirt with multiple seals.

FIG. 5 is an exploded perspective side view of an embodiment of a filter assembly.

FIG. 6 is a perspective view of the filter assembly of FIG. 5 in an assembled configuration.

FIG. 7 is a perspective side view of an embodiment of a curved filter assembly.

FIG. 8A is a perspective schematic side view of an embodiment of a facemask assembly with multi-mounts.

FIG. 8B is a perspective schematic side view of another embodiment of a facemask assembly with multi-mounts.

FIG. 8C is a perspective schematic side view of another embodiment of a facemask assembly with multi-mounts.

FIG. 9 is a perspective schematic side view of an embodiment of a multi-mount and an attachment end of an accessory.

FIG. 10 is a perspective schematic side view of another embodiment of a multi-mount and an attachment end of an accessory.

FIG. 11 is a schematic side view of an embodiment of a facemask assembly worn by a wearer.

FIG. 12A is a perspective schematic side view of an embodiment of a facemask assembly with an accessory attached to the facemask assembly.

FIG. 12B is a perspective schematic side view of an embodiment of a facemask assembly with an accessory attached to the facemask assembly.

FIG. 13 is a perspective schematic side view of an embodiment of a facemask assembly with a light accessory attached to the facemask assembly.

FIG. 14 is a perspective front view of an embodiment of a facemask assembly with an eye shield attached to the facemask assembly.

FIG. 15 is a perspective side view of the facemask assembly of FIG. 14 with an eye shield attached to the facemask assembly.

FIG. 16 is a front view of an embodiment of a facemask assembly with a neck gaiter attached to the facemask assembly.

FIG. 17 is an exploded perspective side view of another embodiment of a filter assembly.

FIG. 18 is an exploded perspective side view of another embodiment of a filter assembly.

FIG. 19

### DETAILED DESCRIPTION OF ILLUSTRATIVE EMBODIMENT(S)

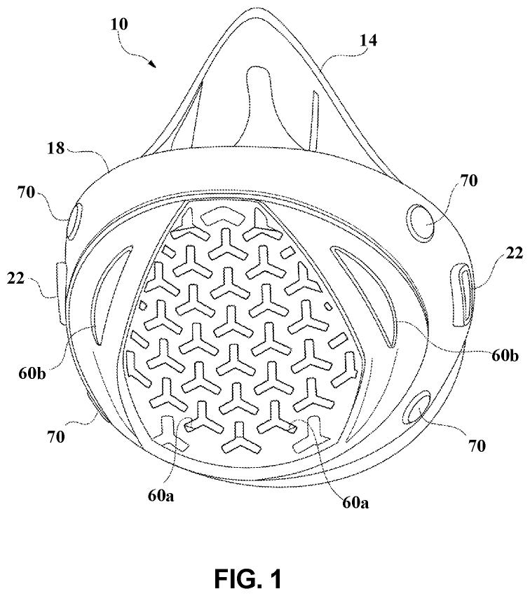

FIG. 1 shows facemask assembly 10. In some embodiments, facemask assembly 10 includes core frame 12, facial skirt 14, filter assembly 16, front section 18, and/or head harness/strap system 20. In some embodiments, facemask assembly 10 can be reusable. In some embodiments, facemask assembly 10 can be, at least in part, made of materials which can be disinfected and sterilized. In some embodiments, facemask assembly 10 can be self-sanitizing. In some embodiments, facemask assembly 10 can be customizable. In some embodiments, facemask assembly 10 can be the facemask assembly described in International Application PCT/US2022/023875 filed on Apr. 7, 2022, which is incorporated herein by reference in its entirety.

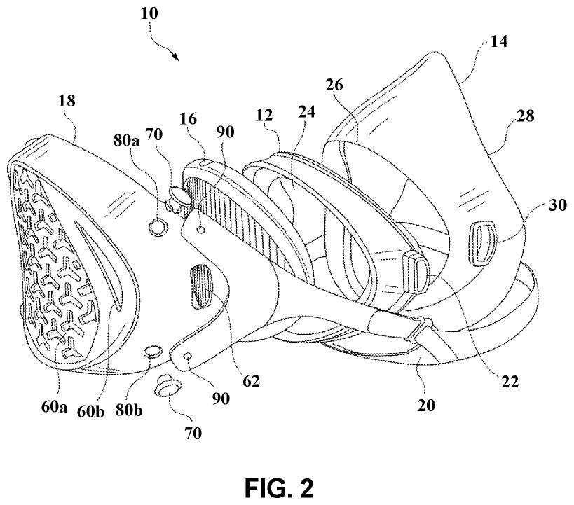

In some embodiments, facemask assembly 10 can be held together using core frame 12 (shown in FIG. 2). In some embodiments, facial skirt 14, filter assembly 16 and/or front section 18 can be attached to core frame 12.

In some embodiments, core frame 12 can include one or more attachment members 22 configured to attach facial skirt 14 and/or front section 18 to core frame 12. In some embodiments, attachment members 22 protrude from an outer surface of core frame 12. In some embodiments, core frame 12 can include at least two attachments members 22. In some embodiments, attachment members 22 can be located on opposite sides of core frame 12. For example, in some embodiments, such as the one shown in FIG. 1, core frame 12 can include attachment member 22 on either side of core frame 12. In some embodiments, attachment members 22 can serve as vents.

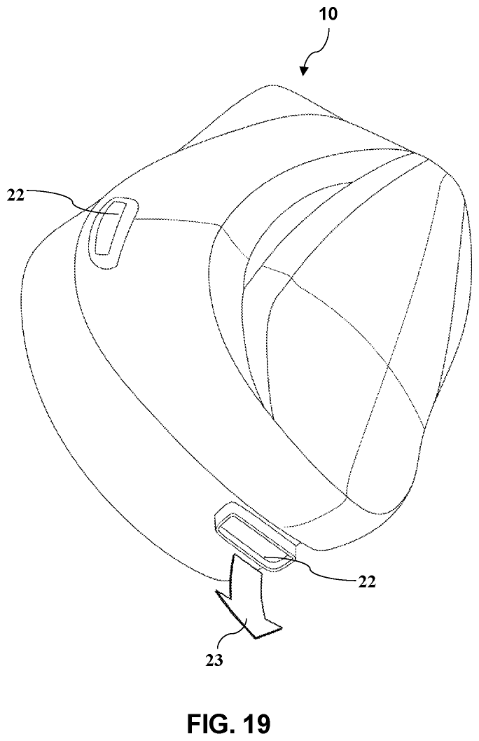

In some embodiments, such as shown in FIG. 19, attachment members 22 act as vents. In some embodiments, at least one attachment member includes a one-way valve to allow air to flow in only one direction. In the embodiment shown in FIG. 19, one attachment member 22 is located on the lower section of core frame 12 and incorporates a valve which prevents, or at least reduces the chance of air from entering the mask but allows air to exit the mask as shown by arrow 23. In some embodiments, airflow into and out of the mask, and resulting humidity, can be controlled by incorporating one or more valves into one or more attachment members.

In some embodiments, core frame 12 includes core frame opening 24 defined by the perimeter of core frame 12. In some embodiments, core frame opening 24 can be configured to receive filter assembly 16.

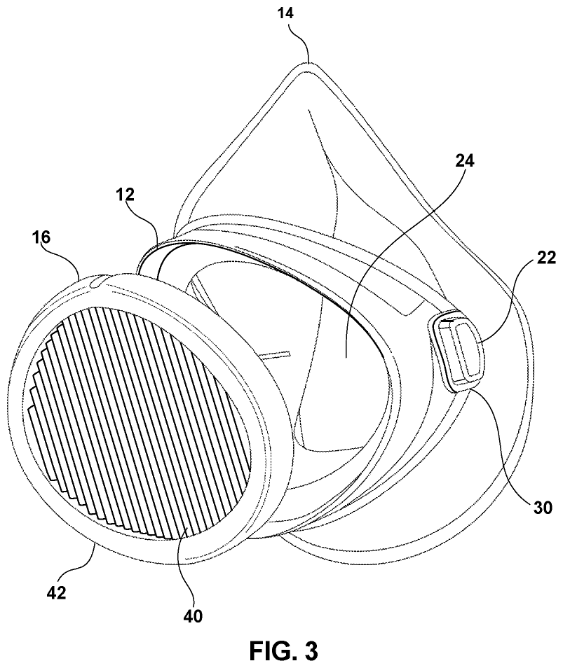

In some embodiments, core frame 12 can be made of a rigid or semi-rigid material, such as, but not limited to, various polymers, elastomers, plastics, rubbers, and/or silicones. In some embodiments, to assemble facemask assembly 10, facial skirt 14 is attached to core frame 12 using attachment members 22. In some embodiments, filter assembly 16 can be placed within core frame opening 24. In some embodiments, front section 18 can then be placed over filter assembly 16 and attached to core frame 12 using attachment members 22. In some embodiments, core frame 12 can contact filter assembly 16 (see FIGS. 2-3) and front section 18 when facemask assembly 10 is assembled, sealing the facemask together.

In some embodiments, facemask assembly 10 includes facial skirt 14. In some embodiments, facial skirt 14 has elastic properties and contacts the face of a wearer. In some embodiments, facial skirt 14 can be constructed from materials such as, but not limited to, soft silicone that conforms to the wearer's face and can create a seal with the wearer's skin. In some embodiments, facial skirt 14 can be produced via additive manufacturing to allow for greater customization. In some embodiments, facial skirt 14 includes an inner perimeter defining an opening at first end 26. In some embodiments, first end 26 can be sized to fit over core frame 12. In some embodiments, first end 26 can create an air-tight seal with core frame 12. In some embodiments, the outer perimeter at a second end 28 of facial skirt 14 defines an opening formed therein that fits over the nose and around the mouth of a wearer, sealing facemask assembly 10 to the wearer's face.

In some embodiments, facial skirt 14 can be attached to core frame 12. For example, in some embodiments, facial skirt 14 can include facial skirt apertures 30 configured to receive core frame attachment members 22. In some embodiments, facial skirt apertures 30 are sized to correspond with the shape of attachment members 22. In some embodiments, facial skirt 14 includes a facial skirt aperture 30 for each attachment member 22 on core frame 12. In some embodiments, facial skirt 14 can be attached to core frame 12 via adhesive attachment. In some embodiments, facial skirt 14 and core frame 12 can be a unitary piece.

In some embodiments, facial skirt 14 can be attached to core frame 12 by inserting core frame 12 through second end 28 and pulling core frame 12 through facial skirt 14 until attachment members 22 enter facial skirt apertures 30. In some embodiments, facial skirt 14 can be stretched over core frame 12 such that attachment members 22 enter facial skirt apertures 30.

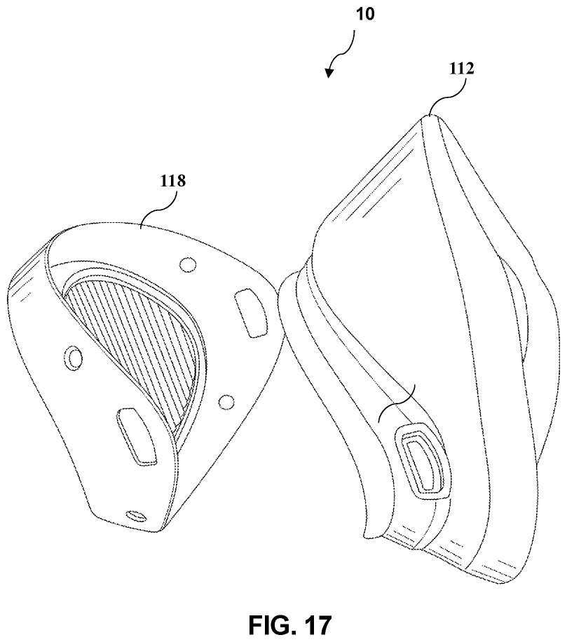

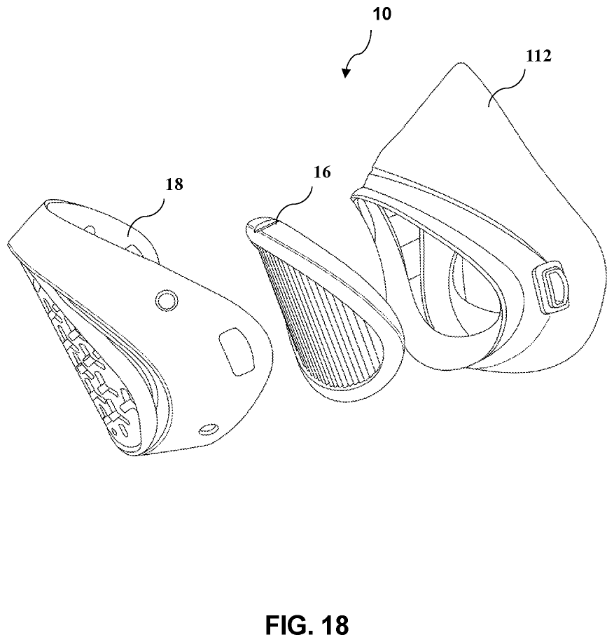

In some embodiments, such as shown in FIG. 17 and FIG. 18, core frame 112 incorporates a facial skirt directly into core frame 112 during the manufacturing process. In some embodiments, core frame 112 with the integrated facial skirt includes some, if not all, of the features of core frame 12 and/or facial skirt 14.

In some embodiments, such as shown in FIG. 17, front section 118 incorporates a filter assembly directly into front section 118 during the manufacturing process. In some embodiments, front section 118 with the integrated filter assembly includes some, if not all, of the features of front section 118 and/or filter assembly 16.

In some embodiments, facial skirt 14 can be customized to a specific wearer, such as for example via additive manufacturing. In some embodiments, facial skirt 14 can be configured to the unique facial topography of a specific wearer. Adjusting various properties of facial skirt 14 such as, but not limited to, its weight, length, width, depth, and/or the shape of the outer perimeter at second end 28 based on the distinct facial structure of the wearer, can create a facemask that optimally conforms to the wearer's face and provides a seal with the skin. A customized facial skirt 14 can also maximize, or at least increase, wearer comfort.

In some embodiments, facial skirt 14, can be made from materials that balance wearer comfort with structural/functional properties: thickness, elasticity, flexibility, coefficient of friction, etc. The materials can provide structural integrity such that facial skirt 14 conforms to the contours of the wearer's face and creates a seal with the skin. Tactile properties of facial skirt 14 such as smoothness and/or texture of the outer perimeter and/or other surfaces that contact the wearer's skin can be adjusted. In some preferred embodiments, facial skirt 14 can be made from a silicone, silicone-based materials, thermal polyurethanes (TPU) and/or synthetic rubbers.

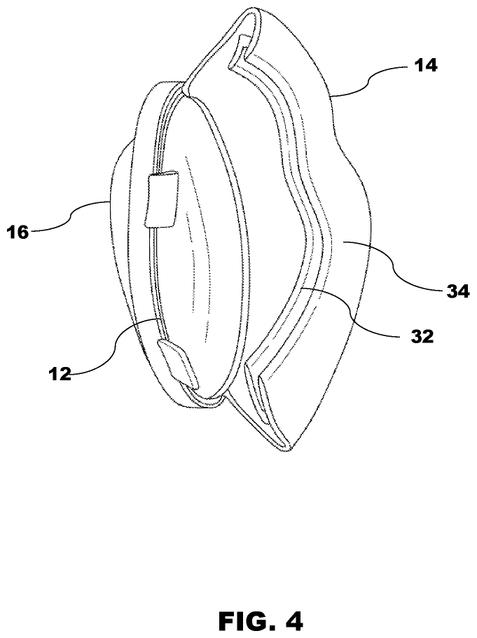

In at least some embodiments, facial skirt 14 includes multiple seal-layers to protect various face shapes and sizes. In some embodiments, such as shown in FIG. 4, facial skirt 14 has two seal-layers, layer 32 and layer 34. In some embodiments, facial skirt 14 has three seal-layers. In some embodiments, facial skirt 14 has four seal-layers. In some embodiments, facial skirt 14 has five seal-layers. In some embodiments, facial skirt 14 has at least six seal-layers.

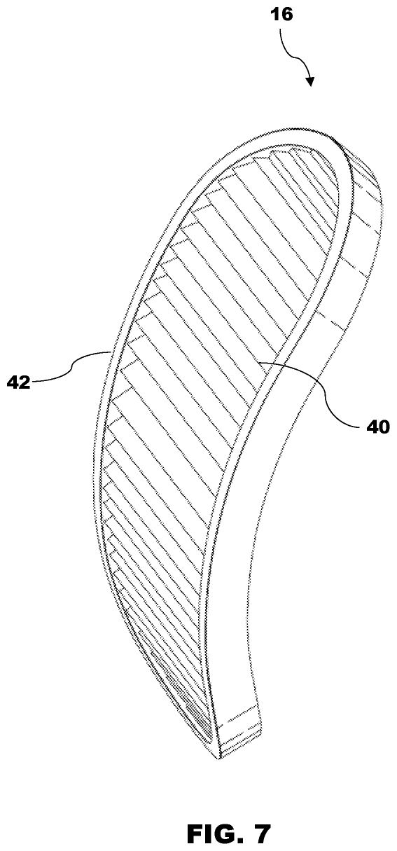

In some embodiments, facemask assembly 10 includes filter assembly 16. Filter assembly 16 can be configured to hold filter material 40. In some embodiments, such as the one shown in FIG. 7, filter assembly 16 is made of a filter frame 42 and filter material 40. In some embodiments, filter assembly 16 can be attached to core frame 12. In some embodiments, filter frame 42 can be shaped to correspond with core frame opening 24 such that filter assembly 16 fits into core frame opening 24. In some embodiments, filter assembly 16 is attached to core frame 12 via a friction-fit. For example, in some embodiments, filter frame 42 can be made of a thermoplastic polyurethane (TPU), silicone, or thermoplastic vulcanizate (TPV) such that filter frame 42 contacts the inner surface of core frame 12 and is retained with friction forces. In some embodiments, filter assembly 16 can be attached to core frame 12 using other attachment means such as with, but not limited to, clips, adhesives, screws, bolts, magnets, and/or nuts. In some embodiments, filter assembly 16 is permanently affixed to core frame 12.

In some embodiments, filter assembly 16 includes filter frame 42 with filter material 40 extended between filter frame 42. In some embodiments, filter material 40 is flat. In some embodiments, filter material 40 is pleated.

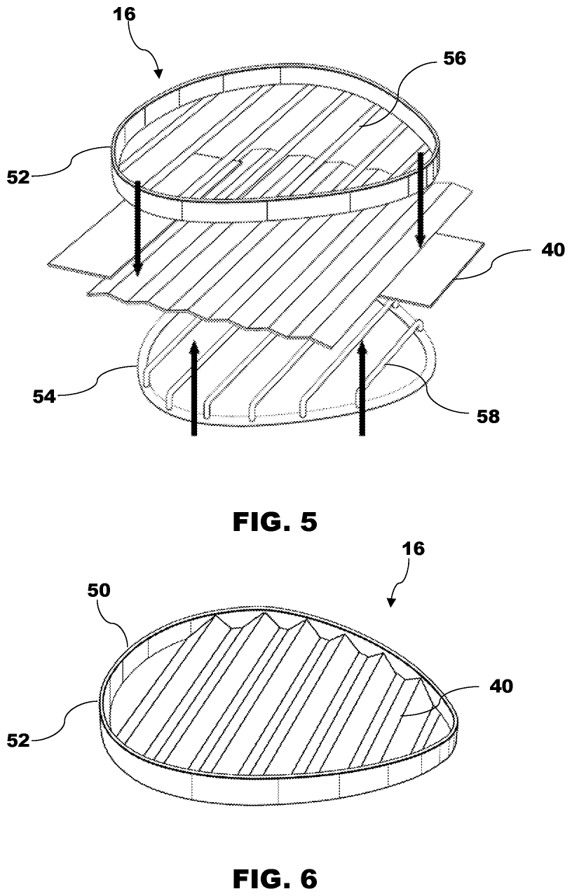

In some embodiments, such as the one shown in FIG. 5 and FIG. 6, filter assembly 16 can include two-piece frame 50 comprising top piece 52 and bottom piece 54 that can sandwich filter material 40.

In some embodiments, filter assembly 16 is configured to accept a pleated filter material 40 (such as shown in FIG. 5). In some embodiments, filter material 40 is positioned between top piece 52 and bottom piece 54. In some embodiments, filter material 40 is initially flat and becomes pleated as it conforms to horizontal portions 56 and horizontal portions 58 of top piece 52 and bottom piece 54, respectively, when pressed between frame top piece 52 and bottom piece 54. For example, in some embodiments, top piece 52 can include flat horizontal portions 56 and bottom piece can include raised horizontal portions 58. Flat horizontal portion 56 and raised horizontal portions 58 can be arranged such that when top piece 52 and bottom piece 54 are pressed together, raised horizontal portions 58 fit in the spaces between flat horizontal portions 56. In this way, filter material 40 between top piece 52 and bottom piece 54 can be retained in a pleated shape. In some embodiments, top piece 52 and bottom piece 54 can include vertical portions such that when filter material 40 is sandwiched between top piece 52 and bottom piece 54 the pleats run vertically within filter frame 50. In at least some embodiments, the pleated shape increases the breathable surface area as well as increases the angularity of the oblique angle of attack experienced by an inhaled particulate and/or pathogen. In some embodiments, top piece 52 is not needed for the filter assembly 16 and instead, core frame 12 operates as the top piece.

In some embodiments, filter assembly 16 has a pleated/folded design that positions filter material 40 away from the wearer's face, so that it does not interfere with talking and facial expressions, provides a large filtration area, is more breathable, and/or speeds the evaporation of moisture from within the mask. In some embodiments, filter material 40 filters over 94% of particulates.

In at least some embodiments, the use of a pleated filter between the filter frame increases the surface area of filter material available for interacting with the various particulates, viruses, and the like, by at least 10% more than a flat filter positioned between the filter frame. In at least some embodiments, the use of a pleated filter between the filter frame increases the surface area of filter material available for interacting with the various particulates, viruses, and the like, by at least 20% more than a flat filter positioned between the filter frame. In at least some embodiments, the use of a pleated filter between the filter frame increases the surface area of filter material available for interacting with the various particulates, viruses, and the like, by at least 30% more than a flat filter positioned between the filter frame. In at least some embodiments, the use of a pleated filter between the filter frame increases the surface area of filter material available for interacting with the various particulates, viruses, and the like, by at least 40% more than a flat filter positioned between the filter frame. In at least some embodiments, the use of a pleated filter between the filter frame increases the surface area of filter material available for interacting with the various particulates, viruses, and the like, by at least 50% more than a flat filter positioned between top piece the filter frame. In at least some embodiments, the use of a pleated filter between the filter frame increases the surface area of filter material available for interacting with the various particulates, viruses, and the like, by at least 60% more than a flat filter positioned between the filter frame. In at least some embodiments, the use of a pleated filter between the filter frame increases the surface area of filter material available for interacting with the various particulates, viruses, and the like, by at least 70% more than a flat filter positioned between the filter frame. In at least some embodiments, the use of a pleated filter between the filter frame increases the surface area of filter material available for interacting with the various particulates, viruses, and the like, by at least 80% more than a flat filter positioned between the filter frame. In at least some embodiments, the use of a pleated filter between the filter frame increases the surface area of filter material available for interacting with the various particulates, viruses, and the like, by at least 90% more than a flat filter positioned between the filter frame. In at least some embodiments, the use of a pleated filter between the filter frame increases the surface area of filter material available for interacting with the various particulates, viruses, and the like, by at least 100% more than a flat filter positioned between the filter frame.

In some embodiments, the use of a pleated filter between the filter frame increases the surface area of filter material available for interacting with the various particulate, viruses, and the like, by three to ten times (300% to 1,000%) more than a flat filter positioned between the filter frame.

In some embodiments, filter material 40 has a single active surface. In other embodiments, filter material 40 can have multiple active surfaces. In certain embodiments, the active material contains silver which acts as a biocidal element. In other or the same embodiments, filter material 40 can be optimized for the capture of non-infectious particles such as dust or air pollution particulates or to filter using a chemical and/or biological operation. In some embodiments, the active material is silver particles. In some embodiments, the active material is silver nanoparticles. In some embodiments filter material 40 is a spunbond nylon fabric bonded with a silver substrate during the manufacturing process, to which nano fiber is added.

In some embodiments, filter material 40 is an antimicrobial material.

In some embodiments, filter material 40 releases positively-charged silver ions activated by the moisture of breathing, which inhibit and/or eliminate microbes and viruses. In some embodiments, filter material 40 is self-cleaning and/or germ-resistant. In some embodiments, filter material 40 is made of a material that reduces the human coronavirus 229E by at least 98% at two hours (ISO 18184:2019 antiviral textile test). In some embodiments, filter material 40 is made of a material that demonstrates a log reduction of 7.0 and a percent reduction of 99.999990.(The JIS L 1902:2015 Antimicrobial Efficacy test).

In some embodiments, filter material 40 is made of a material that shows a mean filtration efficiency of 98% at 60 L/min flow rate on 0.3-micron particle, 2% NaCl with a low pressure drop of only 128 Pa. (TSI 8130).

In some embodiments, filter material 40 reduces the chance of contamination and self-contamination between disinfection and sterilization cycles.

In at least some embodiments, filter material 40 can be used multiple times without needing to be replaced. In some embodiments, filter material 40 can be used hundreds of times without needing to be replaced. In some embodiments, filter assembly 16 is configured to be disposable. In some embodiments, filter frame 42 and/or filter frame 50 are configured to be cleaned and reused while filter material 40 is configured to be disposed.

In some embodiments, filter assembly 16 is curved and/or s-shaped. For example, as shown in FIG. 7, in some embodiments, filter assembly 16 can be curved. In some embodiments, such as that shown in FIG. 3, filter assembly 16 can be flat. In at least some embodiments, filter frame 42 can be made of a flexible material. In some embodiments, filter frame 42 aids in forming a seal. In some embodiments, filter frame 42 is molded around filter material 40. In at least some embodiments, the pleats of the filter material 40 are configured to run vertically when a user wears facemask assembly 10. This is found to lead to improvements in a user's comfortability and speech clarity.

In some embodiments, front section 18 can be attached to core frame 12 and can cover filter assembly 16. In some embodiments, front section 18 can be the outermost layer/element of the facemask assembly 10. In some embodiments, front section 18 can be a pre-filter. In some embodiments, facemask assembly 10 can include a separate pre-filter between front section 18 and filter assembly 16. In some embodiments, front section 18 supports the extraction of moisture from the mask.

In some embodiments, front section 18 can include gap(s) 60a and/or gap(s) 60b to provide ventilation for a wearer and/or to filter large particles. In some embodiments, gap(s) 60a and/or gap(s) 60b expose filter material 40 and allow airflow through front section 18. In some embodiments, gap(s) 60a and/or gap(s) 60b can be a variety of shapes. In some embodiments, front section 18 can include differently shaped gap(s) 60a and/or gap(s) 60b. For example, in some embodiments, such as shown in FIGS. 1-2, three-branched, “Y” shaped gaps 60a can be located on a central section of front section 18 and a crescent-like gap 60b can be located to each side of the central section of front section 18.

In some embodiments, front section 18 can include front section attachment apertures 62 configured to receive core frame attachment members 22 located. In some embodiments, front section attachment apertures 62 are sized to correspond with the shape of attachment members 22. In some embodiments, front section 18 includes a front section attachment aperture 62 for each attachment member 22 on core frame 12. In some embodiments, front section 18 can be attached to core frame 12 using clips and/or fasteners such as, but not limited to, screws, bolts, magnets, and/or nuts.

In some embodiments, front section 18 can be an interchangeable front section, such that facemask assembly 10 can be used with a variety of front sections 18. In some embodiments, interchangeable front sections 18 can offer various degrees of protection, filtration efficiency, and/or comfortability. For example, in some embodiments, front section 18 can be made of various materials to suit various environments. For example, in some embodiments, front section 18 can be configured to be used in areas with high humidity or in dry areas.

In some embodiments, front section 18 can have different shapes to be used with multiple facial structures, allowing a single facemask assembly 10 to be used by multiple individuals with various facial structures.

In some embodiments, front section 18 can be made of a hard plastic, among other materials. In some embodiments front section 18 can be made of a thin plastic material that improves the speech clarity of the user by resonating. In some embodiments, front section 18 can be a rigid or semi-rigid structure constructed from materials such as, but not limited to, various fabrics, polymers, elastomers, plastics, rubbers, and/or silicones. In some embodiments, front section 18 is made of a frame covered by a textile. In some embodiments, front section 18 is large enough to cover the whole face of a wearer.

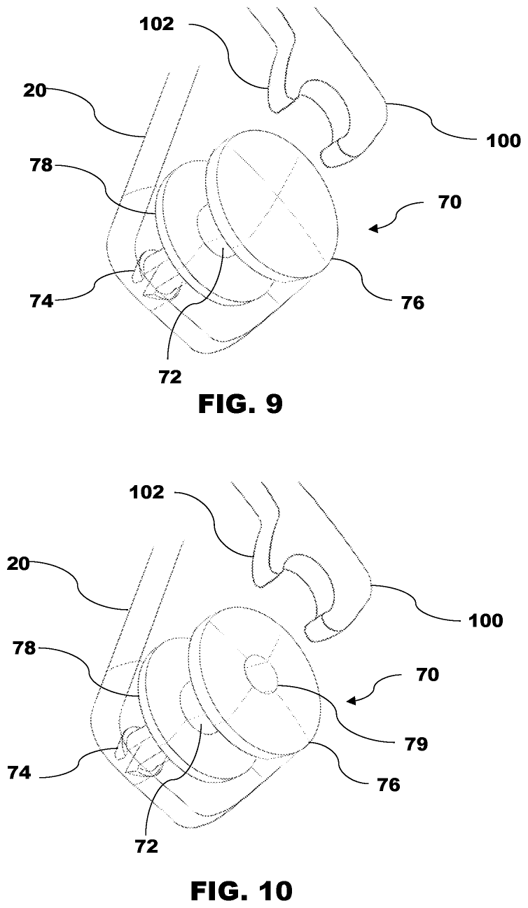

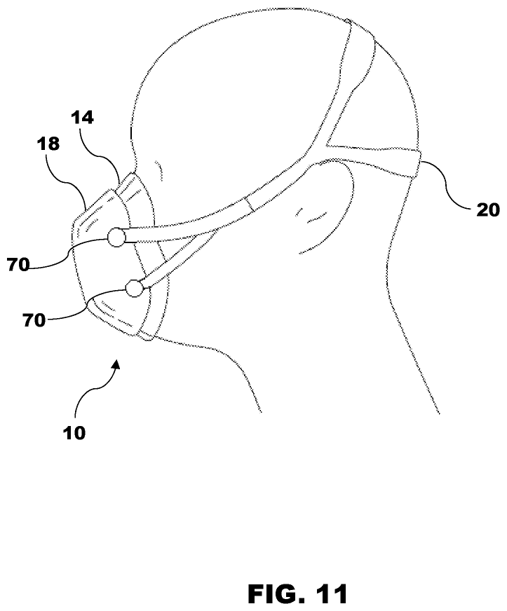

In some embodiments, front section 18 includes at least one multi-mount 70. In some embodiments, such as shown in FIG. 9 and FIG. 10, multi-mount 70 can include cylindrical body 72 with attachment end 74 and first flange/collar 76 at the opposite end. In some embodiments, multi-mount 70 includes multiple flanges/collars. In some embodiments, a second flange/collar 78 extends radially from cylindrical body 72 and is located between attachment end 74 and first flange/collar 76. In some embodiments, second flange/collar 78 is spaced from first flange/collar 76.

In some embodiments, the use of multiple flanges allows multiple accessories to be attached to a single multi-mount.

In some embodiments, facemask assembly 10 includes multiple multi-mounts 70. In some embodiments, facemask assembly 10 includes at least two multi-mounts 70 located on opposite sides of front section 18. In some embodiments, such as shown in FIG. 1, facemask assembly 10 includes four multi-mounts 70.

In some embodiments, front section 18 includes holes configured to receive multi-mounts 70. In some embodiments, front section 18 includes multiple holes. For example, in some embodiments, front section 18 includes upper hole 80a and lower hole 80b on each side of front section 18.

In some embodiments, multi-mounts 70 can be attached to front section 18 by placing attachment end 74 of multi-mount 70 through hole 80. In some embodiments, attachment end 74 of multi-mount 70 can include a pin or rivet snap configured to enter hole 80 and secure multi-mount 70 to front section 18. In some embodiments, multi-mount 70 can attach to facemask assembly 10 via clips, adhesives, screws, bolts, magnets, and/or nuts.

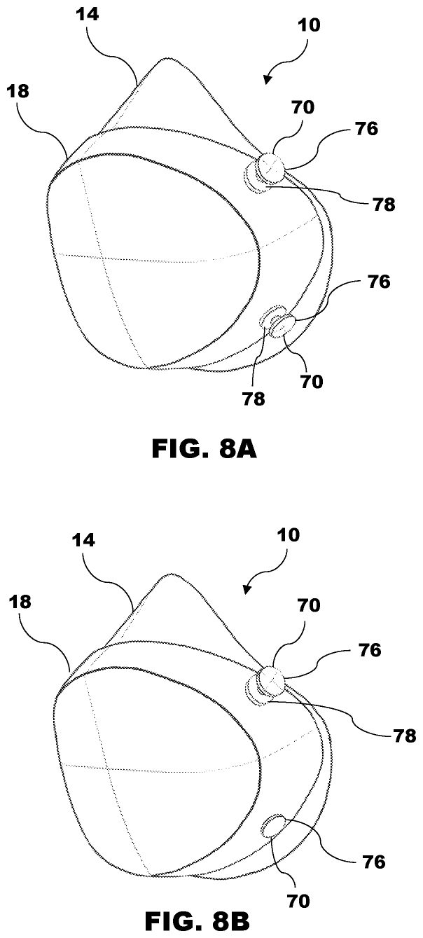

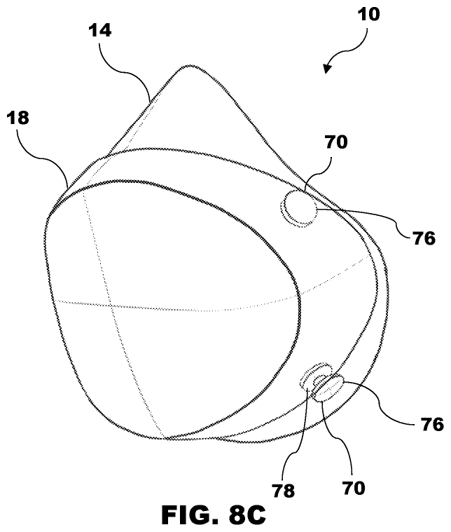

In some embodiments, multi-mounts 70 can be used to attach items such as, but not limited to, head harness/strap system 20 and/or accessories to facemask assembly 10. In some embodiments, facemask assembly 10 can use a variety of multi-mounts to place facemask assembly in a variety of configurations. For example, in some embodiments, facemask assembly 10 can include multi-mounts with only a first flange/collar 76 and/or multi-mounts with first flange/collar 76 and second flange/collar 78. FIGS. 8A-8C show embodiments of facemask assembly 10 utilizing different combinations of multi-mounts 70. For example, in some embodiments, as shown in FIG. 8A, multi-mounts with first flange/collar 76 and second flange/collar 78 are used. In some embodiments, such as those shown in FIGS. 8B-8C, multi-mounts with first flange/collar 76 and second flange/collar 78 and multi-mounts 70 with only first flange/collar 76 are used. In some embodiments, multi-mount 70 can be placed in a stored configuration by pushing the mount 70 towards front section 18, such that either first flange/collar 76 or second flange/collar 78 (if present) abuts front section 18.

In some embodiments, multi-mounts 70 can be used to attach head harness/strap system 20 to facemask assembly 10. For example, in some embodiments, head harness/strap system 20 can include ends including holes 90 (shown in FIG. 2) configured to receive multi-mounts 70. In some embodiments, to attach head harness/strap system 20 to front section 18, multi-mount 70 can be placed through hole 90 on head harness/strap system 20 and then through hole 80 on front section 18. In some embodiments, head harness/strap system 20 can be secured between front section 18 and the bottom surface of second flange/collar 78 (shown in FIGS. 9-10). In some embodiments, if second flange/collar 78 is not present, head harness/strap system 20 can be secured between front section 18 and first flange/collar 76.

In some embodiments, head harness/strap system 20 includes a single strap with two ends and each end can be attached to front section 18 via a multi-mount 70. In some embodiments, head harness/strap system 20 can include multiple straps configured to be attached to front section 18. In some embodiments, for example, such as shown in FIG. 2 and FIG. 11, head harness/strap system 20 includes a branched strap system including four attachable strap ends (two similar strap ends are included on the opposite side not shown in FIG. 2 and FIG. 11) that can be attached to front section 18 using multi-mounts 70.

In some embodiments, the length of head harness/strap system 20 is adjustable. In some embodiments, this is accomplished using a glide, a triglide, a buckle, and/or hook-and-loop fasteners. In some embodiments, a crown section is configured to accommodate ponytails and/or hair buns. In at least some embodiments, head harness/strap system 20 is customized to the face of a wearer. In some embodiments, the head harness/strap system 20 can be the strap system described in International Application PCT/US2022/023875 filed on Apr. 7, 2022, which has been incorporated by reference in its entirety above.

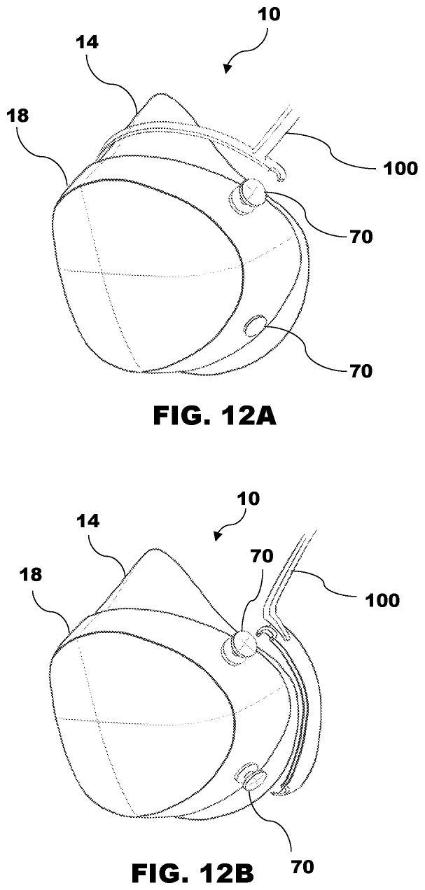

In some embodiments, multi-mounts 70 can be used to mount other accessories 100 to the facemask assembly 10, such as, but not limited to, lighting, an eye protection/shield, magnifiers, environmental sensors, authentication devices, and/or an augmented reality display. In some embodiments, accessory 100 can include an attachment end including hook 102. In some embodiments, accessory 100 can be attached via a snap-fit to cylindrical body 72 of multi-mount 70 between first flange/collar 76 and second flange/collar 78. In some embodiments, first flange/collar 76 can include hole 79 extending into cylindrical body 72 allowing for additional mounting and attachment. In some embodiments, accessory 100 can be attached to one or more multi-mounts 70. For example, as shown in FIG. 12A and FIG. 12B, accessory 100 can be attached to two multi-mounts 70. In some embodiments, as shown in FIG. 12A, accessory 100 can be attached to multi-mounts 70 on opposite sides of front section 18 (in at least some embodiments, two similarly located multi-mounts 70 and features for attaching mounts 70 are present on the side of facemask assembly 10 not shown in FIGS. 12A-B). In some embodiments, as shown in FIG. 12B, accessory 100 can be attached to two multi-mounts 70 on the same side of front section 18. In some embodiments, accessory 100 can be attached to all multi-mounts 70 on front section 18. In some embodiments, multiple accessories 100 can be attached to facemask assembly 10 at once. In some embodiments, multi-mounts 70 can attach head harness/strap system 20 and at least one accessory 100 to facemask assembly 10 at once.

In some embodiments, accessory 100 can attach to multi-mounts 70 via clips, adhesives, screws, bolts, magnets, and/or nuts.

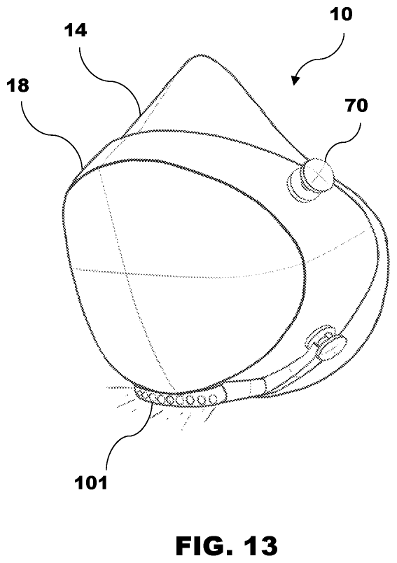

In some embodiments, accessory 100 can be lighting accessory 101. Lighting accessory 101 can be attached to facemask assembly 10 to provide light for the wearer in a poorly lit area, eliminating the need for a wearer to hold a flashlight. Thus, a wearer's hands can be free to use for other purposes. In some embodiments, as shown in FIG. 13, lighting accessory 101 can be attached to two multi-mounts 70 on opposite sides of front section 18. In some embodiments, lighting accessory 101 can be attached to two multi-mounts 70 on the same side of front section 18. In some embodiments, lighting accessory 101 can be attached to all multi-mounts 70 on front section 18. In some embodiments, lighting accessory 101 can include a hooked ends that can be attached via a snap-fit to cylindrical body 72 of multi-mount 70 between first flange/collar 76 and second flange/collar 78. In some embodiments, lighting accessory 101 can attach to multi-mounts 70 via clips, adhesives, screws, bolts, magnets, and/or nuts.

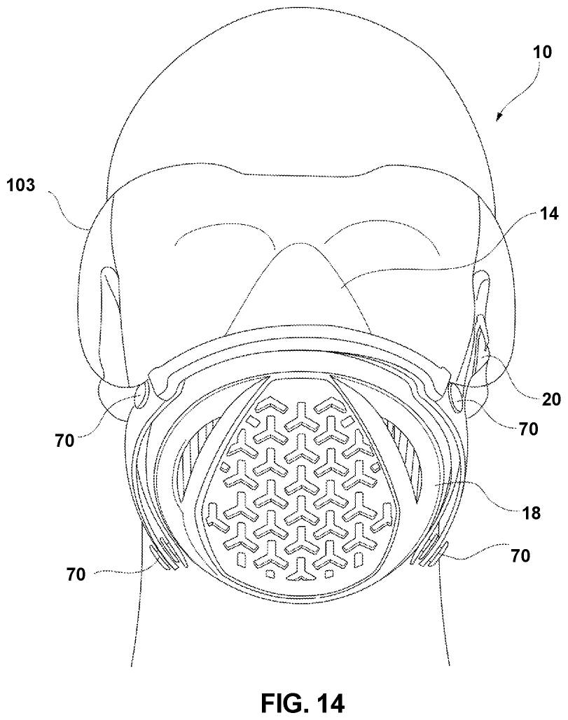

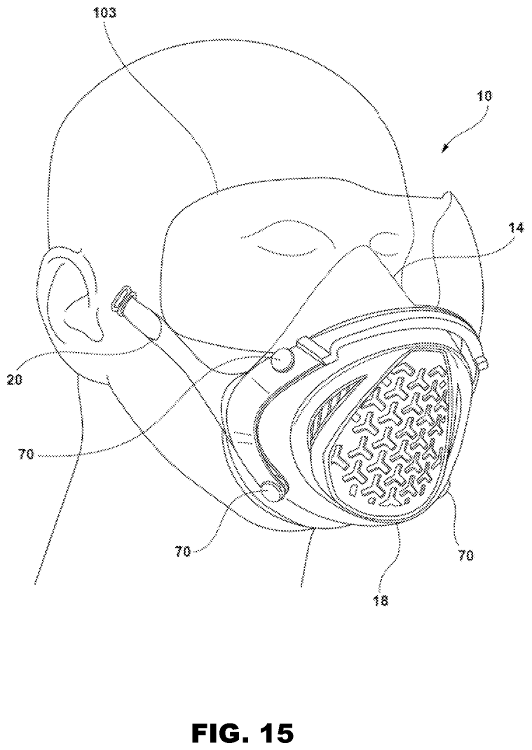

In some embodiments, such as shown in FIG. 14 and FIG. 15, accessory 100 can be an eye shield 103. Eye shield 103 can be attached to facemask assembly 10 to protect a wearer's eyes from particulate. In some embodiments, the eye shield 103 is transparent. In some embodiments, eye shield 103 can be attached to facemask assembly using multi-mounts 70. In some embodiments, eye shield 103 can be attached to two multi-mounts 70 on opposite sides of front section 18. In some embodiments, eye shield 103 can be attached to two multi-mounts 70 on the same side of front section 18. In some embodiments, as shown in FIGS. 14 and 15, eye shield 103 can be attached to all multi-mounts 70 on front section 18. In some embodiments, eye shield 103 can include hooked ends that can snap-fit to cylindrical body 72 of multi-mounts 70. The eye shield 103 can also rest against the wearer's forehead and/or cheekbones.

In most, if not all embodiments, eyeglasses can be worn with facemask assembly 10 without the fear of having them fog up due to the airtight seal. In some embodiments, front section 18 covers the whole face of a wearer and thereby also serves as an eye shield.

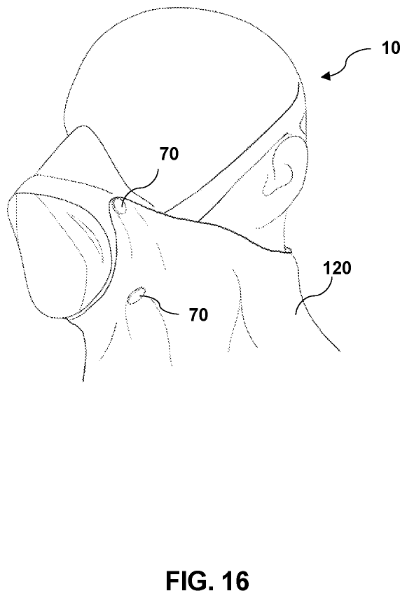

In some embodiments, such as shown in FIG. 16 accessory 100 can be a neck gaiter 120. Neck gaiter 120 can be attached to facemask assembly 10 to protect a wear's head, hair, face and/or neck from particulate, flames and/or environmental factors such as extreme heat and cold. In some embodiments, the neck gaiter 120 is made, at least in part, of one or more flame-resistant and/or flame-retardant materials. In some embodiments, the neck gaiter 120 is made, at least in part, of one or more thermal-regulating materials. In some embodiments, the neck gaiter 120 is made, at least in part, of a phase change materials.

In some embodiments, neck gaiter 120 can be attached to facemask assembly using multi-mounts 70. In some embodiments, neck gaiter 120 can be attached to four multi-mounts 70 of front section 18. In some embodiments, neck gaiter 120 can be attached to two multi-mounts 70 of front section 18.

In some embodiments, neck gaiter 120 is a singular tube-shaped material. In some embodiments, neck gaiter 120 can be configured to open and can incorporate closures, such as but not limited to, zippers, snaps, hook-and-loop systems, buttons, and/or magnets.

In some embodiments, facemask assembly 10, or portions thereof, can be made from polyolefins such as, but not limited to, polyethylene (PE), polypropylene (PP), polytetrafluoroethylene (PTFE), and/or polyvinyl chloride (PVC). In some embodiments, facemask assembly 10, or portions thereof, can be made from silicones such as polydimethylsilane (PDMS). In some embodiments, facemask assembly 10, or portions thereof, can be made from polyacrylates such as, but not limited to, polymethyl methacrylate (PMMA). In some embodiments, facemask assembly 10, or portions thereof, can be made from polyesters such as, but not limited to, polyethylene terephthalate (PET), Polylactic Acid (PLA), polyglycolic acid (PGA), and/or polydioxanone (PDO). In some embodiments, facemask assembly 10, or portions thereof can be made from polyethers such as, but not limited to, polyether ether ketone (PEEK) and/or polyether sulfone (PES). In some embodiments, facemask assembly 10, or portions thereof, can be made from polyamide (Nylon), polyurethane (PU), and/or polycaprolactone. In some embodiments, facemask assembly, 10 or portions thereof, is made of thermal polyurethane (TPU), polyamide (nylon), polyurethane (PU), polyethylene (PE), polypropylene (PP), and/or polytetrafluoroethylene (PTFE).

In some embodiments, the plasticity and flexibility of facemask assembly 10 or portions thereof, can be increased with various plasticizers that promote durability of the material.

In some embodiments, the entire facemask assembly 10 can be boiled/autoclaved and is reusable. In some embodiments, facemask assembly 10 can be cleaned by chemical disinfectant methods. In some embodiments, filter material 40 can be designed to be boiled or autoclaved. In some embodiments, strap system 20 can be boiled and/or autoclaved. In certain embodiments, head harness/strap system 20 does not need to be disassembled from facemask assembly 10 before being boiled and/or autoclaved. In some embodiments, the entire facemask assembly 10 can be cleaned and/or boiled without disassembling it. In some embodiments, facemask assembly 10 can withstand sterilization temperatures in the inclusive range of 100-132° C. In some embodiments, facemask assembly 10 can withstand sterilization temperatures in the inclusive range of 100-160° C.

In some embodiments, the entire facemask assembly 10 can be disinfected using sterilization chemicals.

In some embodiments, facemask assembly 10 is configured to be used at least one-hundred-and-eighty times. In some embodiments, such as when facemask assembly 10 is used in a hospital setting, filter material is configured to last at least for thirty uses. In some embodiments, such as when facemask assembly 10 is used in a hospital setting, filter material is configured to last at least for fifty uses. In some embodiments, most, if not all, of the parts of facemask assembly 10 are replaceable. In some embodiments facemask assembly 10 has a shelf-life of over a decade.

In some embodiments, facemask assembly 10 includes diaphragms within resonators that can increase the volume and clarity of the wearer's speech.

In at least some embodiments, facemask assembly 10 provides bi-directional protection.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

It is understood that the invention is not limited to the particular components described herein, as these can vary as persons familiar with the technology involved here will recognize. It is also to be understood that the terminology used herein is used for the purpose of describing particular embodiments only, and is not intended to limit the scope of the process. It also is to be noted that as used herein and in the appended claims, the singular forms “a,” “an,” and “the” include the plural reference unless the context clearly dictates otherwise. Thus, for example, a reference to “a linker” is a reference to one or more linkers and equivalents thereof known to those skilled in the art. Similarly, the phrase “and/or” is used to indicate one or both stated cases can occur, for example, A and/or B includes (A and B) and (A or B).

Unless defined otherwise, technical, and scientific terms used herein have the same meanings as commonly understood by one of ordinary skill in the art to which the process pertains. The embodiments of the process and the various features and advantageous details thereof are explained more fully with reference to the non-limiting embodiments and/or detailed in the following description. It should be noted that features of one embodiment can be employed with other embodiments as the skilled artisan would recognize, even if not explicitly stated herein.

Furthermore, particular elements of the present invention as described in the embodiments above can be incorporated into facemask assemblies in other suitable combinations or arrangements, for example to suit particular applications.

The examples given above are merely illustrative and are not meant to be an exhaustive list of all possible embodiments, applications, or modifications of the present electrochemical device. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the chemical arts or in the relevant fields are intended to be within the scope of the appended claims.

What is claimed is:

1. A facemask assembly comprising:
a first multi-mount;
a core frame;
a facial skirt
a filter assembly;
an accessory configured to attach to said first multi-mount; and
a front section,
wherein said front section includes a first hole configured to receive said first multi-mount,
wherein said first multi-mount comprises:
a cylindrical body;
an attachment end configured to attach to said front section;
a first collar; and
a second collar spaced from said first collar,
wherein said first collar and said second collar are configured to allow attachment of multiple accessories to said first multi-mount.

2. The facemask assembly of claim 1 wherein said filter assembly comprises
a filter material; and
a filter frame.

3. The facemask assembly of claim 2 wherein said filter material is pleated.

4. The facemask assembly of claim 2 wherein said filter frame comprises:
a top piece; and
a bottom piece,
wherein said top piece and said bottom piece are configured to sandwich said filter material.

5. The facemask assembly of claim 2 wherein said facial skirt comprises:
a first layer; and
a second layer.

6. The facemask assembly of claim 1 wherein said core frame comprises a first attachment member configured to attach said facial skirt to said core frame.

7. The facemask assembly of claim 6 wherein said core frame comprises a second attachment member configured to attach said front section to said core frame.

8. The facemask assembly of claim 6 wherein said first attachment member serves as a vent for said facemask assembly.

9. The facemask assembly of claim 7 wherein said second attachment member serves as a vent for said facemask assembly.

10. The facemask assembly of claim 2 wherein said filter material is a spunbond nylon fabric bonded with a silver substrate during a manufacturing process, to which nano fiber is added.

11. The facemask assembly of claim 2 wherein said filter material is an antimicrobial material.

12. The facemask assembly of claim 2 wherein said filter material releases positively-charged silver ions activated by moisture.

13. The facemask assembly of claim 2 wherein said front section comprises:
a y-shaped gap; and
a crescent-shaped gap.

14. The facemask assembly of claim 1, wherein said front section includes a second hole configured to receive a second multi-mount.

15. The facemask assembly of claim 1 wherein said accessory is a neck gaiter.

16. The facemask assembly of claim 1 wherein said accessory is a lighting accessory.

17. The facemask assembly of claim 1 wherein said accessory is an eye shield.

18. The facemask assembly of claim 1 wherein said accessory is a magnifier.

19. The facemask assembly of claim 1 wherein said accessory is an environmental sensor.

20. The facemask assembly of claim 1 wherein said accessory is an augmented reality display.
